(19) United States
(12) Patent Application Publication
(10) Pub. No.: US 2019/0279475 A1
(43) Pub. Date: Sep. 12, 2019

(54) Customer Interaction Using Visible Light Communication

(71) Applicant: Eaton Intelligent Power Limited, Dublin (IE)

(72) Inventors: David George Watt, Forest Park, GA (US); Parth Joshi, Atlanta, GA (US); Nam Chin Cho, Peachtree City, GA (US)

(21) Appl. No.: 16/294,618

(22) Filed: Mar. 6, 2019

Related U.S. Application Data
(60) Provisional application No. 62/639,826, filed on Mar. 7, 2018.

(51) Int. Cl. G08B 7/06; H04B 10/116; G08B 5/36; G08B 3/10; G06Q 10/02

(52) U.S. Cl. CPC G08B 7/068; H04B 10/116; G06Q 10/02; G08B 3/10; G08B 5/36

(57) ABSTRACT

A method of customer interaction includes receiving, by a management system, reservation information of a customer for a business location. The method further includes receiving, by the management system, a first message indicating an arrival of the customer at the business location. The first message is received by the management system from a lighting fixture that received the first message from a mobile device via a visible light transmission. The lighting fixture is located at the business location. The method also includes transmitting, by the management system, a second message to the mobile device in response to receiving the first message.

### CROSS REFERENCE TO RELATED APPLICATIONS

The present application claims priority to U.S. Provisional Patent Application No. 62/639,826, filed Mar. 7, 2018 and titled “Customer Service Management,” the entire content of which is incorporated herein by reference.

### TECHNICAL FIELD

The present disclosure relates generally to visible-light communication, and in particular to use of visible light communication in service management.

### BACKGROUND

In some businesses, such as restaurants, hotels, etc., customer interactions are often handled in a fragmented manner. For example, when a customer that made a restaurant reservation by phone or online arrives at a restaurant, the person has to provide his/her name to a restaurant staff for the staff to be aware of the person's arrival. The restaurant management has no knowledge of the arrival of the customer until the customer informs the restaurant staff. The wait staff becomes aware of the customer's presence upon being informed by the host staff, upon seeing the customer at the table or being informed by the customer. During a customer's time at a restaurant, the customer may need to flag the wait staff for attention including to pay the bill for service/meals. As another example, when a person that has a reservation arrives at a hotel, the staff is unaware of the person's arrival until the person reaches the check-in counter, perhaps, after waiting in line. The person has to provide his/her name before the reservation is verified and a room access is provided to the person. After checking in, the person has to typically find the assigned room following room number information posted on walls. For check outs, hotel staff typically provides print-outs of charges by walking to rooms of guests that are scheduled to check out. Guests may also need to go to the check-out counter to complete the check out. Such fragmented customer service may sometimes be inefficient and inconvenient to the customer. Other businesses, such as car rental, etc., may also have similar fragmented customer service processes. Thus, a solution that improves business-customer interactions may be desirable.

### SUMMARY

The present disclosure relates generally to visible-light communication, and in particular to use of visible light communication in service management. In an example embodiment, a method of customer interaction includes receiving, by a management system, reservation information of a customer for a business location. The method further includes receiving, by the management system, a first message indicating an arrival of the customer at the business location. The first message is received by the management system from a lighting fixture that received the first message from a mobile device via a visible light transmission. The lighting fixture is located at the business location. The method also includes transmitting, by the management system, a second message to the mobile device in response to receiving the first message.

In another example embodiment, a method of customer interaction includes receiving, by a mobile device, reservation confirmation information of a customer for a business location. The method further includes transmitting, by a mobile device, a first message indicating an arrival of the customer at the business location, where the mobile device transmits the first message to a first light fixture that receives the first message from the mobile device via a visible light transmission and transmits the first message to a business management system. The lighting fixture is located at the business location. The method also includes receiving, by the mobile device, a second message from the business management system through the lighting fixture.

In another example embodiment, a customer interaction system includes a mobile device that includes a first light source and a camera. The system further includes a lighting fixture that includes a second light source and a light sensor. The lighting fixture is located at a business location. The system also includes a business management system. The mobile device is configured to transmit a message to the lighting fixture via a first visible light transmission by the first light source in response to a user input provided to the mobile device. The message indicates an arrival of a customer at the business location. The lighting fixture is configured to transmit the message to the management system via a radiofrequency signal.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates a customer interaction system according to an example embodiment;

FIG. 2 illustrates a light fixture used in the system of FIG. 1 according to an example embodiment;

FIG. 3 illustrates the mobile device of FIG. 1 according to an example embodiment;

FIG. 4 illustrates the management system of the customer interaction system of FIG. 1 according to an example embodiment;

FIG. 5 illustrates a floor plan of a business establishment displayed on a display screen of the mobile device of FIG. 1 according to an example embodiment;

FIG. 6 illustrates a lighting control interface and service request interface displayed on the display screen of the mobile device of FIG. 1 according to an example embodiment; and

FIG. 7 illustrates a bill displayed on the display screen of the mobile device of FIG. 1 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. Reference numerals used in multiple drawings may designate like or corresponding, but not necessarily identical, elements.

### DETAILED DESCRIPTION OF THE EXAMPLE EMBODIMENTS

In the following paragraphs, example embodiments will be described in further detail with reference to the figures. In the description, well-known components, methods, and/or processing techniques are omitted or briefly described. Furthermore, reference to various feature(s) of the embodiments is not to suggest that all embodiments must include the referenced feature(s).

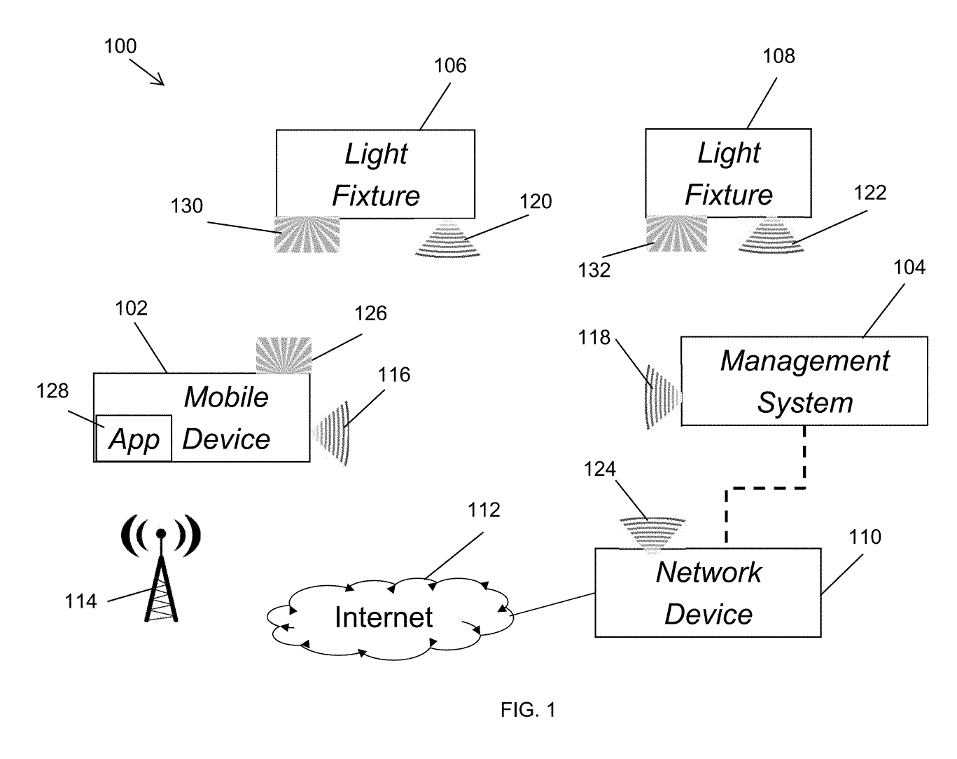

Turning now to the figures, particular example embodiments are described. FIG. 1 illustrates a customer interaction system 100 according to an example embodiment. In some example embodiments, the customer interaction system 100 includes a management system 104, lighting fixtures 106, 108, and a network device 110. The management system 104, the lighting fixtures 106, 108, and the network device 110 may be located at a business establishment such as a restaurant, a hotel, etc. The management system 104 may include one or more management devices such as point-of-sale devices, a laptop, a desktop, a tablet, etc.

In some example embodiments, the management system 104 and the lighting fixtures 106, 108 may communicate with each other and other devices wirelessly or via wired connections. For example, the management system 104 and the lighting fixtures 106, 108 may communicate with each other and other devices via the network device 110. To illustrate, the management system 104 and the lighting fixtures 106, 108 may communicate with each other and other devices using wireless (i.e., radiofrequency) signals 118, 120, 122, 124 that may be compliant with a communication standard such as Wi-Fi, Bluetooth Low Energy (BLE), etc. The network device 110 may include a wireless and/or wired router, a gateway device, etc. and may be communicably coupled to the internet 112.

In some example embodiments, the lighting fixtures 106, 108 may have visible light communication capability. Illumination (visible) lights 130, 132 emitted by the respective lighting fixture 106, 108 may be used to both illuminate an area near or below the lighting fixtures 106, 108, respectively, and for visible light communication when data is encoded or otherwise embedded in the illumination lights 130, 132. For example, each lighting fixture 106, 108 may include components that are used to encode/embed data in the illumination light 130, 132 as can be readily understood by those of ordinary skill in the art with the benefit of this disclosure. To illustrate, each lighting fixture 106, 108 may include a controller, a light source, etc. to generate the respective illumination light 130, 132 and encode/embed data therein. Each lighting fixture 106, 108 may also include components to receive a visible light and to decode/extract data from the visible light. To illustrate, each lighting fixture 106, 108 may include a controller, a camera or a light sensor, etc.

In some example embodiments, the customer interaction system 100 may communicate with a mobile device 102 (e.g., a user device) capable of wireless and/or wired electrical communication and visible light communication. For example, the mobile device 102 may be a mobile phone, a tablet, a laptop, etc. The mobile device 102 may use wireless (radiofrequency) signals 116 to communicate with the management system 104 through a communication tower 114 that is communicably coupled to the internet 112. The wireless signals 116 may be compliant with one or more communication standards such as LTE, Wi-Fi, BLE, etc.

In some example embodiments, the mobile device 102 may communicate with the management system 104 and the lighting fixtures 106, 108 wirelessly through the network device 110. For example, the mobile device 102, the management system 104, and the lighting fixtures 106, 108 may use the wireless signals 116, 118, 120, 122, 124 that are compliant with a Wi-Fi standard to wireless communicate with each other through the network device 110.

In some example embodiments, the mobile device 102 may use visible light communication (VLC) to communicate with the lighting fixtures 106, 108 and other devices that have VLC capability. To illustrate, the mobile device 102 may include a camera to receive a visible light (e.g., the illumination lights 130, 132) emitted by the lighting fixtures 106, 108 and other light sources. The mobile device 102 may receive the visible light and decode/extract data from the light when the visible light includes data. The mobile device 102 may also include a light source that can emit a visible light 126 that is encoded with data or that otherwise includes data. For example, a controller of the mobile device 102 may control the encoding of data in the visible light 126 and the emission of the visible light 126.

In some example embodiments, the mobile device 102 may use its flash LED, which is typically used when taking photos, to encode the data in the light emitted by the flash LED. Alternatively, the mobile device 102 may cause its screen (e.g., an LCD screen, an OLED screen, etc.) to flash (e.g., on and off) based on the data to be communicated. In some alternative embodiments, the mobile device 102 may display data (e.g., encrypted or encoded data) via imagery such as a QR-code on the display screen of the mobile device 102. For example, the lighting fixtures 106, 108 and other devices that communicate with the mobile device 102 using imagery may include a camera sensor (e.g., a CMOS camera sensor) to capture the image, such as a QR-code, displayed by the mobile device 102.

In some example embodiments, a person may use the mobile device 102 to make a reservation at a restaurant. For example, the mobile device 102 may use radiofrequency signals, such as the wireless signals 116, to transmit and receive reservation information. To illustrate, a customer may access the website of the restaurant or a third party website to make the reservation. Alternatively or in addition, the mobile device 102 may include or may access a customer service application 128, and the customer may use the customer service application 128 to make the reservation. Upon making a reservation, a customer may obtain confirmation information, such as a reservation number or other identifying information. For example, the customer service application 128 may obtain the confirmation information automatically from a reservation computer/server when the customer uses the customer service application 128 to make the reservation. The confirmation information may be stored in the mobile device 102. The reservation information (e.g., name, the number of people, etc.) and the confirmation information may be transferred to the management system 104 of the restaurant, which may use the information to reserve a table and prepare to provide service to the customer(s). The confirmation information can be used during further interaction between the customer (e.g., using the mobile device 102) and the management system 104 of the restaurant.

In some example embodiments, the mobile device 102 may execute the customer service application 128 to inform the management system 104 of the restaurant of the arrival of the customer. To illustrate, upon the customer's arrival at the parking lot, at the entrance of the restaurant, and/or at a location near the restaurant, the mobile device 102 may inform the management system 104 via the lighting fixture 106. For example, the mobile device 102 may communicate the customer's arrival to the management system 104 through the lighting fixture 106 in response to an input provided to the mobile device 102 by the customer input. Alternatively or in addition, the mobile device 102 may communicate the customer's arrival to the management system 104 through the lighting fixture 106 upon the mobile device 102 detecting the lighting fixture 106. To illustrate, the lighting fixture 106 may be located in a parking lot near the restaurant or at the entrance (inside or outside) of the restaurant. The mobile device 102 may communicate the customer's arrival to the management system 104 of the restaurant by communicating with the lighting fixture 106 using the visible lights 126, 130. Alternatively, the mobile device 102 and the lighting fixture 106 may communicate with each other using wireless signals 116, 120. The lighting fixture 106 may communicate with the management system 104 using wireless (RF) signals 120, 118.

In some example embodiments, the confirmation information obtained by the mobile device 102 at the time that the reservation is made by the customer may be used to uniquely identify the customer and/or the mobile device 102 in the communication between the mobile device 102 and the components of the customer interaction system 100 such as the management system 104. Alternatively or in addition, the customer may log into or otherwise access the customer service application 128 on the mobile device 102, and the login or other related information may be used to uniquely identify the customer and/or the mobile device 102 in the communication between the mobile device 102 and the components of the customer interaction system 100.

In response to being informed of the customer's arrival, the management system 104 may inform a host staff. For example, a management server of the management system 104 may send a message to a management device (e.g., a tablet) used by the host staff indicating that the customer associated with the particular confirmation information has arrived. The management server may also send a floor plan of the restaurant to the management device indicating the table reserved for the customer. The management system 104 may also inform the customer, for example, via the customer service application 128 of the mobile device 102, whether the reserved table is ready, wait time, etc. The management system 104 may also send the floor plan of the restaurant indicating the reserved table to the mobile device 102, and the mobile device 102 may execute the customer service application 128 to display the floor plan including the reserved table. The reserved table may be identified in the displayed floor plan by one or several means including a different color from other displayed tables, a symbol, a text, a flashing icon, etc. The customer may follow the floor plan displayed on the mobile device 102 to find the reserved table without waiting for a host staff Alternatively, the host staff may guide the customer to the reserved table based on the floor plan provided by the management server.

In some example embodiments, a lighting fixture at or above the reserved table may also flash its light to indicate the reserved table to the customer. To illustrate, the lighting fixture 108 may be positioned at, above, or near the reserved table, and the lighting fixture 108 may flash its light in response to receiving a message that includes the confirmation information from the mobile device 102, for example, via the visible light 132. When the customer reaches or becomes seated at the reserved table, the mobile device 102 may execute the customer service application 128 to inform the management system 104 that the customer is at the reserved table. For example, the customer may provide an input to the customer service application 128 via the input interface of the mobile device 102, and the mobile device 102 may communicate with the lighting fixture 108 using visible lights 126, 132, and the lighting fixture 108 may communicate with the management system 104 using wireless signals 122, 118. Alternatively, the mobile device 102 and the lighting fixture 108 may communicate with each other using wireless signals 116, 122.

In some alternative embodiments, the lighting fixture 108 may include an occupancy sensor that detects whether a table at, below, or near the lighting fixture 108 is occupied. For example, when a table is occupied, the lighting fixture 108 may transmit an occupancy indicator to the management system 104 using wireless signals 122.

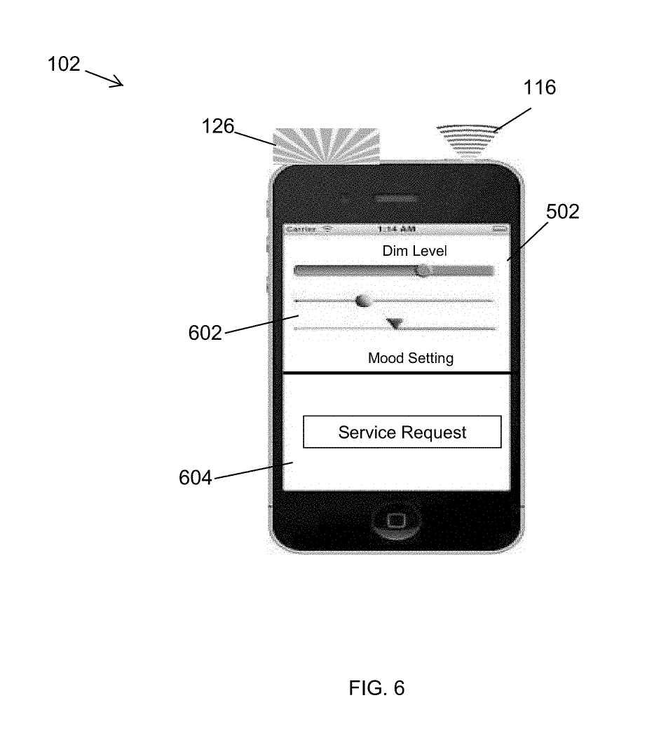

In some example embodiments, the customer may use the mobile device 102 to adjust the visible light 132 emitted by the lighting fixture 108. For example, the mobile device 102 may execute the customer service application 128 that displays a light control interface on the mobile device 102 as shown in FIG. 6. To illustrate, in response to the customer's input, for example, via the touch sensitive display of the mobile device 102, the mobile device 102 may communicate with the lighting fixture 108 using the visible light 126 to change dim level, color temperature, etc. of the visible light 132.

In some example embodiments, the customer may use the mobile device 102 to request service from a wait staff or from a manager. The customer may provide an input to the mobile device 102 that executes the customer service application 128 to communicate with the management system 104 via the lighting fixture 108. For example, the customer may touch a call icon on a touch-sensitive display of the mobile device 102 that results in the mobile device 102 communicating with the lighting fixture 108 using the visible lights 126, 132. The lighting fixture 108 may communicate the information received from the mobile device 102 with the management system 104 using the wireless signal 122. Alternatively, the mobile device 102 may use the wireless signal 116 to communicate with management system 104, for example, through the network device 110.

In some example embodiments, the management system 104 may send the customer's bill to the mobile device 102. Upon receiving the bill, the mobile device 102 may execute the customer service application 128 to display the bill on the display screen of the mobile device 102. For example, the management system 104 may send the bill to the mobile device 102 through the lighting fixture 108. To illustrate, the management system 104 may communicate with the lighting fixture 108 using the wireless signals 118, 122 (e.g., Wi-Fi signals through the network device 110, BLE signals, etc.), and the lighting fixture 108 may communicate with the mobile device 102 using the visible lights 132, 126. In some alternative embodiments, the mobile device 102 and the lighting fixture 108 may communicate with each other using wireless signals 116, 122.

In some example embodiments, the customer's credit card information may be stored in the customer service application 128 or may otherwise be accessible to the customer service application 128, and the customer may pay the bill using the customer service application 128. For example, the customer may press a “PAY” button displayed on the display screen of the mobile device 102 or may otherwise provide an input to the customer service application 128 to make the payment. The mobile device 102 may execute the customer service application 128 to send the credit payment information (e.g., the credit card information, payment amount, etc.) to the management system 104. For example, the mobile device 102 may send the payment information to the lighting fixture 108 using the visible light 126, and the lighting fixture 108 may transmit the received payment information to the management system 104 using wireless signals 122.

In some example embodiments, the management system 104 may process the received payment information and send a payment confirmation (e.g., a receipt) to the customer. Upon receiving the payment confirmation, the mobile device 102 may execute the customer service application 128 to display the bill on the display screen of the mobile device 102. To illustrate, the management system 104 may send the payment confirmation to the mobile device 102 through the lighting fixture 108 using the wireless signals 118 (e.g., Wi-Fi signals through the network device 110, BLE signals, etc.), and the lighting fixture 108 may send the payment confirmation to the mobile device 102 using the visible light 132. In some alternative embodiments, the mobile device 102 and the lighting fixture 108 may communicate with each other using wireless signals 116, 122.

In some example embodiments, the customer interaction system 100 may be used by a hotel to provide customer service. For example, a customer may make a hotel reservation in a similar manner as described above with respect to a restaurant. Upon the arrival of the customer at the hotel, the mobile device 102 may communicate the customer's arrival to the management system 104 of the hotel in a similar manner as described above. For example, the customer may provide an input to the customer service application 128 of the mobile device 102, and the mobile device 102 may execute the customer service application 128 to send a message indicating the customer's arrival. The mobile device 102 of the customer may communicate with the management system 104 through the lighting fixture 106 based on the reservation confirmation information. For example, the mobile device 102 may communicate with the lighting fixture 106 that may be located at or near the entrance of the hotel using visible lights 126, 120.

Upon receiving the information indicating the customer's arrival, a management server of the management system 104 of the hotel may inform the hotel staff, for example, by sending a message to a management device such as a tablet. The management server may also provide information such as the reserved room number to the hotel staff, which may allow the hotel staff to guide the customer to the reserved room without having to check in at a counter. Alternatively or in addition, the management system 104 of the hotel may send information such as reserved room number, a floor plan indicating the reserved room, etc. to the mobile device 102. For example, the management system 104 may send the information to the lighting fixture 106 using the wireless signals 118, and the lighting fixture 106 may send the received information to mobile device 102 using the visible light 130. Upon receiving the information from the management system 104, the customer may head to the reserved room without having to check in at a check in counter.

In some example embodiments, the customer may adjust the lighting inside the reserved room by providing an input to the mobile device 102 that executes the customer service application 128 to communicate lighting control commands to the lighting fixture 108, which may be located in the reserved room. On the customer's check-out date, the management system 104 may send billing information to the mobile device 102 via the lighting fixture 108 in a similar manner as described above with respect to the management system 104 of a restaurant. Upon receiving the billing information, the customer may use the mobile device 102 and the customer service application 128 to send payment information to the management system 104 via the lighting fixture 108 in a similar manner as described above. The management system 104 may also send a receipt to the customer via the lighting fixture 108 upon receiving the payment information from the mobile device 102 via the lighting fixture 106.

In some example embodiments, the customer interaction system 100 may be used by a car rental business to provide customer service. For example, a customer may make a car reservation in a similar manner as described above with respect to a restaurant. Upon the arrival of the customer at the rental location, the mobile device 102 may communicate the customer's arrival to the management system 104 of the hotel in a similar manner as described above. For example, the customer may provide an input to the customer service application 128 of the mobile device 102, and the mobile device 102 may execute the customer service application 128 to send a message indicating the customer's arrival. The mobile device 102 of the customer may communicate with the management system 104 through the lighting fixture 106 based on the reservation confirmation information. For example, the mobile device 102 may communicate with the lighting fixture 106 that may be located at or near the entrance of the rental location using visible lights 126, 120.

Upon receiving the information indicating the customer's arrival, a management server of the management system 104 of the rental business may inform the staff, for example, by sending a message to a management device such as a tablet. The management server may also provide information such as the reserved car type and the car's location to the hotel staff, which may allow the staff to guide the customer to the reserved car without having to check in at a counter. Alternatively or in addition, the management system 104 of may send information such as the reserved car type, a floor plan indicating the location of the car, etc. to the mobile device 102. For example, the management system 104 may send the information to the lighting fixture 106 using the wireless signals 118, and the lighting fixture 106 may send the received information to mobile device 102 using the visible light 130. Upon receiving the information from the management system 104, the customer may head to the reserved car without having to check in at a check in counter.

Upon the customer's arrival to the rental location to return the rented car, the mobile device 102 may communicate the customer's arrival to the management system 104, for example, via the lighting fixture 108. The mobile device 102 may send information indicating the customer's arrival to the lighting fixture 108 using the visible light 126, and the lighting fixture 108 may transmit the information to the management system 104 using the wireless signals 132. In response to receiving the information, the management system 104 may communicate customer's arrival to the staff that may meet the customer before the customer leaves the rental car. The management system 104 may also send billing information and a receipt to the customer via the lighting fixture 108, and the customer use the mobile device 102 and the customer service application 128 to send payment information to the management system 104 via the lighting fixture 108.

By detecting the arrival of a customer at a business establishment (e.g., a restaurant, a hotel, a car rental, etc.), the customer interaction system 100 in communication with the mobile device that executes the customer service application 128 may facilitate the provision of services to the customer and may simplify the interactions between a business and its customers. Further, interactions such as service requests and payments between a business establishment and its customers may be facilitated using visible light communications between the mobile device 102 and one or more lighting fixtures of the business establishment. The use of the reservation confirmation information or other customer/mobile device identifier in the communications between the mobile device 102 of a customer and the management system 104 and other components, such as lighting fixtures 106, 108, enables identification of the customer and/or the mobile device 102 by the management system 104.

Although two lighting fixtures are shown in FIG. 1, the customer interaction system 100 may include more or fewer lighting fixtures that operate in a similar manner as the lighting fixtures 106, 108 without departing from the scope of this disclosure. In some alternative embodiments, the lighting fixtures may use wired communication instead of or in addition to wireless communications to communicate with the management system. Although the above description uses a restaurant, a hotel, and car rental, as examples, the description is applicable to other businesses such other types of businesses that have interactions with customers as can be readily contemplated by those of ordinary skill in the art with the benefit of this disclosure.

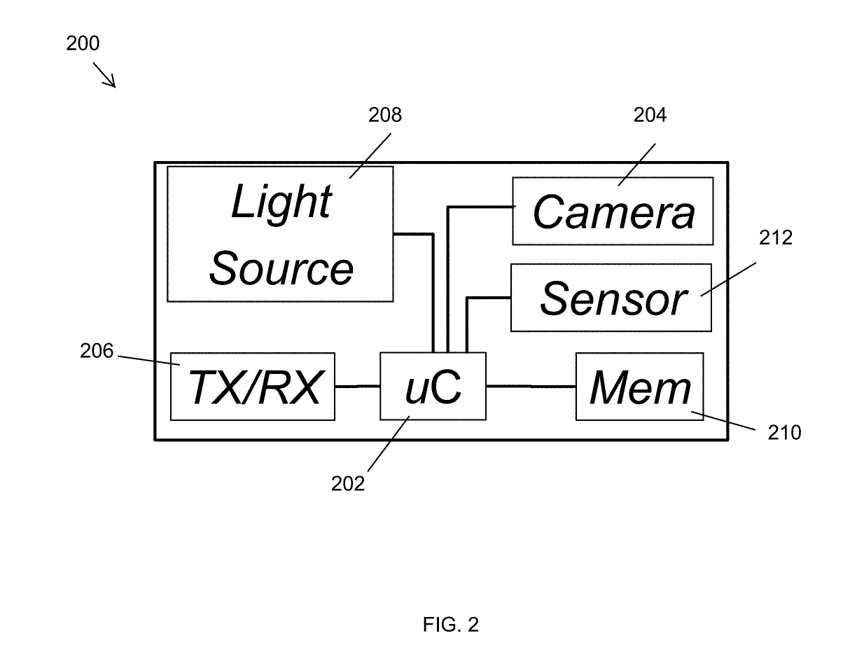

FIG. 2 illustrates a light fixture 200 used in the customer interaction system 100 of FIG. 1 according to an example embodiment. Referring to FIGS. 1 and 2, in some example embodiments, the lighting fixture 200 corresponds to the lighting fixtures 106, 108, and other lighting fixtures that may be part of the customer interaction system 100. The lighting fixture 200 may include a controller 202, a camera component or a light sensor 204, a transceiver 206, a light source 208 (e.g., an LED light source) that can emit a visible light, and a memory device 210. The lighting fixture 200 may also include a sensor component 212 (e.g., a motion sensor).

In some example embodiments, the controller 202 may be a microcontroller or a microprocessor that can execute software code stored in the memory device 210 to perform operations described herein with respect to the lighting fixtures 106, 108. For example, the memory device 210 may include an SRAM and/or a non-volatile memory device that can be used to store executable code and/or data such as data used in the operation of the lighting fixture 200 and data generated during the operation of the lighting fixture 200.

In some example embodiments, the controller 202 may execute software code stored in the memory device 210 to control the light emitted by the light source 208 including the encoding of data in the light for visible light communication (e.g., modulating of the light with the data). The controller 202 may also control the camera component 204 to control the reception of visible light by the camera component 204 and to extract (e.g., decode) and/or process data from the received visible light. The controller 202 may also control the reception and transmission of data by the transceiver 206 and may perform the processing of the data. To illustrate, the controller 202 may adjust the light emitted by the light source 208 based on lighting control commands received through the camera component 204 (i.e., based on data embedded in the visible light received by the camera component 204). Alternatively or in addition, the controller 202 may adjust the light emitted by the light source 208 based on lighting control commands received through the transceiver 206. For example, the transceiver 206 may that transmit and receive radiofrequency (wireless) signals, such as the wireless signal 116-124 shown in FIG. 1.

In some example embodiments, the controller 202 may also control transmission of data via the transceiver 206 and the light source 208 (i.e., embedded in the visible light emitted by the light source). The controller 202 may also control sensing by the sensor component 212 and the transmission of sensor information (e.g., occupancy detection) via the transceiver 206 or the light source 208 (i.e., embedded in the visible light emitted by the light source).

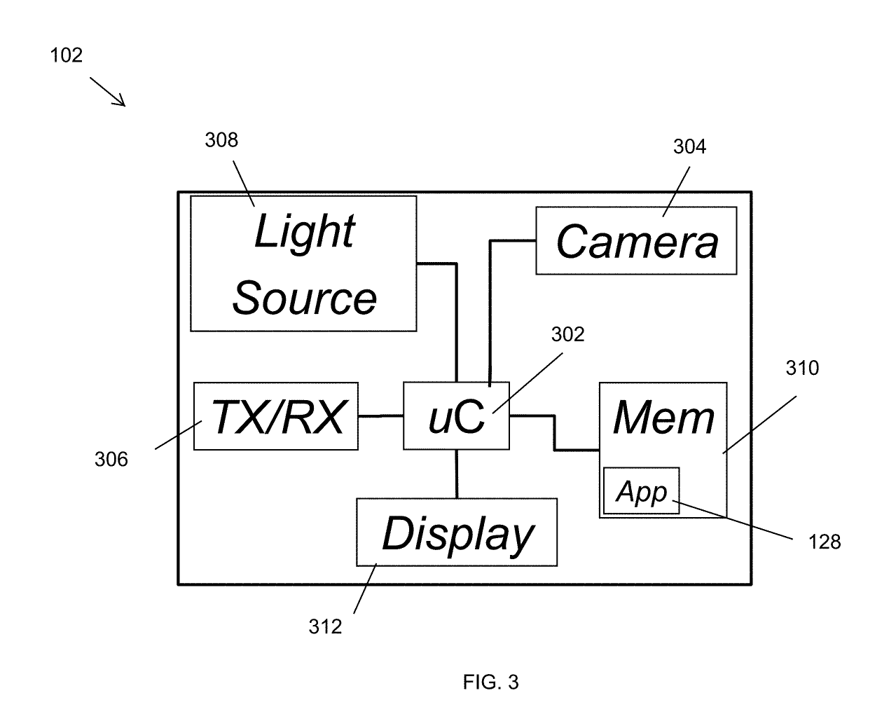

Although particular components are shown in FIG. 3, in some alternative embodiments, one or more of the components of the lighting fixture 200 may be omitted or integrated into another component without departing from the scope of this disclosure. In some alternative embodiments, the lighting fixture 200 may include other components without departing from the scope of this disclosure.

FIG. 3 illustrates the mobile device 102 of FIG. 1 according to an example embodiment. Referring to FIGS. 1 and 3, in some example embodiments, the mobile device 102 may include a controller 302, a camera component 304, a transceiver 306, a light source 308 (e.g., an LED light source) that emits a visible light 126 (e.g., the flash light typically used when taking a picture by the mobile device), a memory device 310, and a display/input interface 312. For example, the controller 302 may be a microcontroller or a microprocessor that can execute software code including the customer service application 128 stored in the memory device 310 to perform operations described herein. For example, the memory device 310 may include an SRAM and/or a non-volatile memory device that can be used to store executable code and/or data such as data used in or generated during the operations of the mobile device 102.

In some examples, the controller 302 may process data received by the camera device 304, the transceiver 306, the display/input interface 312 (e.g., a touch sensitive display) of the mobile device 102, etc. For example, the controller 302 may process user inputs provided via the display/input interface 312. The controller 302 may perform operations based on the received data. To illustrate, the controller 302 may control transmissions by the transceiver 306 and/or the light source 308. The controller 302 may control transmissions of lighting control commands, service requests, payment information, etc. via the visible light 126 and/or the wireless signal 116 based on information received by the mobile device 102. The controller 302 may also control the transmissions of data received via the transceiver 306 or via the display/input interface 312 and the transmissions of information resulting from the processing of the received data.

In some example embodiments, the controller 302 may also control the information provided to the display/input interface 312, etc. To illustrate, the controller 302 may control the display commands and other information through the display/input interface 312. For example, the controller 302 may control the information displayed on the display/input interface 312 of the mobile device 102 as well as the transmission of information through the display/input interface 312. To illustrate, the controlling controller 302 may control the display of data encoded images, such as a QR-code, on the display/input interface 312 of the mobile device 102. The controlling controller 302 may power on and off the display/input interface 312 in a manner that reflects a data pattern.

Although particular components are shown in FIG. 3, in some alternative embodiments, one or more of the components of the mobile device 102 may be omitted or integrated into another component without departing from the scope of this disclosure. In some alternative embodiments, the mobile device 102 may include more or fewer components than shown without departing from the scope of this disclosure.

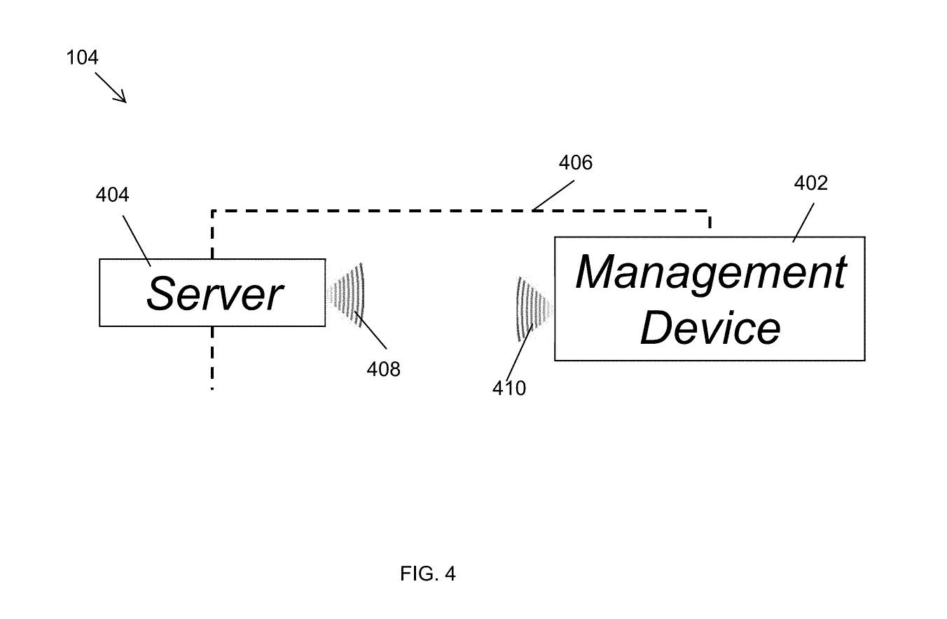

FIG. 4 illustrates the management system 104 of the customer interaction system 100 of FIG. 1 according to an example embodiment. Referring to FIGS. 1 and 4, in some example embodiments, the management system 104 includes a management device 402 and a server 404. The management device 402 and the server 404 may communicate with each other via wired communications (e.g., using Ethernet cable 406) or via wireless communications using wireless (RF) signals 408, 410 (e.g., Wi-Fi signal, BLE signals, etc.).

In some example embodiments, the management device 402 may be a point-of-sale terminal, a laptop, a desktop, etc. To illustrate, the management device 402 may have user input interface and a display interface for business staff to interact with and use the management device 402. For example, the server 404 may receive from the lighting fixture 106 (e.g., via the wireless signal 116) a message indicating the arrival of a customer and may notify business staff of the customer's arrival by sending a notification to the management device 402. The server 404 may also send floor plan and other information related to the customer's reservation to the management device 402 that may display the floor plan and other information on the display screen of the management device 402.

In some example embodiments, the management device 402 may execute software code to process user inputs from and communicate with the mobile device 102, the lighting fixtures 106, 108, the server 404, and other devices. The server 404 may execute software code to process information and communicate with the mobile device 102, the lighting fixtures 106, 108, the management device 402, and other devices. The server 404 and/or the management device 402 may include a memory device to store information such as reservation information, etc. The management device 402 and/or the server 404 may communicate with other devices, such as the mobile device 102, the lighting fixtures 106, 108, etc., using wireless communications (e.g., using Wi-Fi signal, BLE signals, etc.) or wired communication.

In some example embodiments, the management system 104 may include other components such as other management devices, that may communicate with the server 404 or the management device 402. In some alternative embodiments, the management device 402 and the server 404 may be integrated into a single device. In some example embodiments, management system 104 may be part of a reservation system that is used by customers to make reservations.

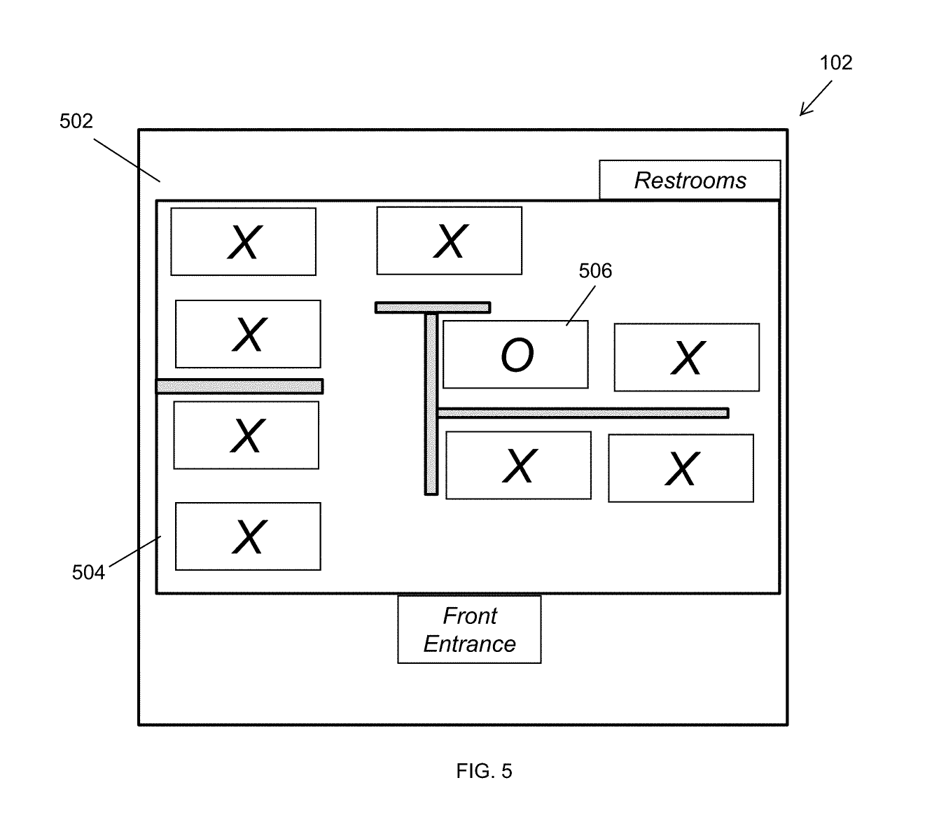

FIG. 5 illustrates a floor plan 504 of a business establishment displayed on a display screen 502 of the mobile device 102 of FIG. 1 according to an example embodiment. For example, the display screen 502 may correspond to the display/input interface 312 shown in FIG. 3. Referring to FIGS. 1, 3, and 5, the mobile device 102 may execute the customer service application 128 to display the floor plan 504, such as the floor plan of a restaurant, a hotel, a car port of a car rental business, etc., received by the mobile device 102 from the management system 104. For example, the floor plan 504 may be received by the mobile device 102 through the lighting fixture 106 as explained in more detail with respect to FIG. 1. The floor plan 504 may show a table/room/car 506 that is reserved for the customer, and the customer may follow the floor plan 504 to the table/room/car 506. By providing the floor plan 504 to the customer upon the customer's arrival, the customer may avoid a check-in process.

FIG. 6 illustrates a lighting control interface 602 and a service request interface 604 displayed on the display screen 502 of the mobile device 102 of FIG. 1 according to an example embodiment. Referring to FIGS. 1, 3, 5, and 6, in some example embodiments, the customer may provide lighting control input to the mobile device 102 using the lighting control interface 602 to change the dim level and other characteristics of a visible light (e.g., the light 130 emitted by the lighting fixture 106, the light 132 emitted by the lighting fixture 108, etc.). In response to the customer's input, the mobile device 102 may send one or more light control commands to the lighting fixture using the visible light 126 or the wireless signals 116.

In some example embodiments, the customer may request service (e.g., from a restaurant wait staff or from a manager) by providing an input to the mobile device 102 using the service request interface 604. In response to the customer's input, the mobile device 102 may execute software code including the customer service application 128 to send one or more light control commands to the lighting fixture (e.g., the lighting fixture 108) using the visible light 126 or the wireless signals 116.

In some alternative embodiments, the lighting control interface 602 and the service request interface 604 may be displayed in a different format and/or configuration than shown in FIG. 6 without departing from the scope of this disclosure.

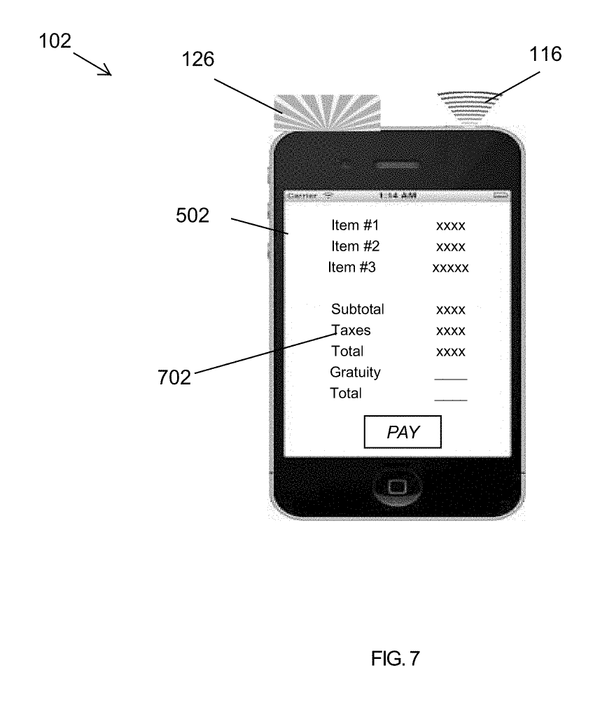

FIG. 7 illustrates a bill 702 displayed on the display screen 502 of the mobile device 102 of FIG. 1 according to an example embodiment. Referring to FIGS. 1, 3, 5, and 7, in some example embodiments, the management system 104 may send a customer's bill (e.g., a dinner bill, hotel room bill, a car rental bill, etc.) to the mobile device 102, and the mobile device 102 may execute a software code including the customer service application 128 to process and display the bill 702 on the display screen 502. For example, the management system 104 may send the bill 702 to the lighting device 108, directly or through the network device 110, using wireless signals 118, and the lighting device 108 may transmit the bill 702 to the mobile device 102 using visible light 132 or the wireless signals 122. The mobile device 102 may receive the visible light 132 (that is encoded with data corresponding to the bill) and extract/decode the data from the visible light 132 and display the bill 702 on the display screen 502. Alternatively, the mobile device 102 may receive the wireless signal 122 and extract/decode the data corresponding to the bill 702 from the wireless signal 122 and display the bill 702 on the display screen 502.

In some example embodiments, the customer may provide one or more inputs to the mobile device 102. For example, the customer may enter a gratuity amount, submit a payment, etc. via the display screen 502, which may be a touch-sensitive screen, or via another input interface of the mobile device 102. For example, the customer may touch the PAY icon displayed on the display screen 502 to pay the bill. To illustrate, the customer may enter credit card or other payment information into the mobile device 102 or the customer's credit card or other payment information may already be stored in or otherwise accessible to the mobile device 102. The mobile device 102 may execute a software code including the customer service application 128 to send the payment information in response to the customer's input to pay the bill 702. The mobile device 102 may send the payment information the lighting device 108, for example, using the visible light 126 (e.g., payment information encoded in the visible light 126), and the lighting device 108 may process and/or send the received payment information to the management system 104 using the wireless signals 122 or a wired connection.

In some example embodiments, upon receiving the payment information, the management system 104 may process the payment information and send a payment confirmation (e.g., a receipt) to the mobile device through the lighting fixture 108. For example, the management system 104 may use the wireless signals 118 to send the payment confirmation to the lighting fixture 108, directly or through the network device 110, and the lighting fixture 108 may transmit the received payment confirmation to the mobile device 102 using the visible light 132 or the wireless signals 122 (directly (e.g., BLE signals) or through the network device 110 (e.g., Wi-Fi signals). The mobile device 102 may receive the visible light 132 and extract/decode the payment confirmation from the visible light 132. The mobile device 102 may also display the payment confirmation on the display screen 502 of the mobile device 102.

In some alternative embodiments, the bill 702 may be displayed in a different format than shown without departing from the scope of this disclosure. In some alternative embodiments, other user input icons may be displayed on the display screen 502 to facilitate user input.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the spirit and scope of the following claims, the scope of which are to be accorded the broadest interpretation so as to encompass modifications and equivalent structures.

What is claimed is:

1. A method of customer interaction, comprising:
receiving, by a management system, reservation information of a customer for a business location;
receiving, by the management system, a first message indicating an arrival of the customer at the business location, wherein the first message is received by the management system from a lighting fixture that received the first message from a mobile device via a visible light transmission and wherein the lighting fixture is located at the business location; and
transmitting, by the management system, a second message to the mobile device in response to receiving the first message.

2. The method of claim 1, wherein the second message is transmitted by the management system via a radiofrequency signal and wherein the lighting fixture receives the second message and transmits the second message to the mobile device via a second visible light transmission.

3. The method of claim 1, wherein the second message includes a floor plan of the business location.

4. The method of claim 3, wherein information indicating a reserved location is included in the floor plan.

5. The method of claim 1, wherein the first message includes reservation confirmation information that is used by the management system to identify communications from the mobile device.

6. The method of claim 1, further comprising receiving, by the management system, a request from the mobile device, wherein the request is received by the management system from a second lighting fixture that received the request from the mobile device via a second visible light transmission and wherein the second lighting fixture is located at the business location.

7. The method of claim 6, further comprising transmitting, by the mobile device, a lighting adjustment command to the second lighting fixture via a third visible light transmission.

8. The method of claim 1, further comprising transmitting, by the management system, a bill to the mobile device, wherein the bill is transmitted by the management system via a radiofrequency signal, wherein a second lighting fixture receives the second message and transmits the second message to the mobile device via a second visible light transmission, and wherein the second lighting fixture is located at the business location.

9. The method of claim 8, further comprising receiving, by the management system, payment information, wherein the payment information is received by the management system from the second lighting fixture that received the payment information from the mobile device via a third visible light transmission.

10. The method of claim 1, wherein the management system includes a restaurant management system.

11. The method of claim 1, wherein the management system includes a hotel management system.

12. The method of claim 1, wherein the management system includes a car rental management system.

13. A method of customer interaction, comprising:
receiving, by a mobile device, reservation confirmation information of a customer for a business location;
transmitting, by the mobile device, a first message comprising the reservation confirmation information and indicating an arrival of the customer at the business location, wherein the mobile device transmits the first message to a first light fixture that receives the first message from the mobile device via a visible light transmission and transmits the first message to a management system and wherein the lighting fixture is located at the business location; and
receiving, by the mobile device, a second message from the management system through the lighting fixture.

14. The method of claim 13, wherein the lighting fixture receives the second message from the management system via a radiofrequency signal and transmits the second message to the mobile device via a second visible light transmission.

15. The method of claim 13, wherein the second message includes a floor plan of the business location.

16. The method of claim 15, further comprising transmitting, by the mobile device, a lighting adjustment command to a second lighting fixture via a second visible light transmission and wherein the second lighting fixture is located at the business location.

17. The method of claim 13, further comprising:
receiving, by the mobile device, a bill from the management system through a second lighting fixture located at the business location; and
transmitting, by the mobile device, payment information to the management system through the second lighting fixture.

18. A customer interaction system, comprising:
a mobile device comprising a first light source and a camera;
a lighting fixture comprising a second light source and a light sensor, wherein the lighting fixture is located at a business location; and
a management system, wherein the mobile device is configured to transmit a message to the lighting fixture via a first visible light transmission by the first light source in response to a user input provided to the mobile device, wherein the message indicates an arrival of a customer at the business location, and wherein the lighting fixture is configured to transmit the message to the management system via a radiofrequency signal.

19. The customer interaction system of claim 18, wherein the mobile device is configured to receive a second message from the lighting fixture via a second visible light transmission by the second light source and wherein the lighting fixture is configured to receive the second message from the management system via a second radiofrequency signal.

20. The customer interaction system of claim 18, wherein the second message includes a floor plan of the business location.
